(19) United States
(12) Patent Application Publication
(10) Pub. No.: US 2023/0026750 A1
(43) Pub. Date: Jan. 26, 2023

(54) MOBILE ELECTRONIC DEVICE HANDWEAR

(71) Applicant: Nicolo Alexis Novilla Duran, Staten Island, NY (US)

(72) Inventor: Nicolo Alexis Novilla Duran, Staten Island, NY (US)

(21) Appl. No.: 17/813,675

(22) Filed: Jul. 20, 2022

Related U.S. Application Data
(60) Provisional application No. 63/223,883, filed on Jul. 20, 2021.

(51) Int. Cl. H04B 1/3888; A45F 5/00; A45C 11/00

(52) U.S. Cl. CPC H04B 1/3888; A45F 5/00; A45C 11/00; A45C 2011/002; A45F 2200/0516; A45F 2005/008

(57) ABSTRACT

An electronic device handwear embodying a glove sleeve that retains a mobile phone “hands free” for outdoor activities in a main pocket by way of a pocket material along an outward facing surface of the glove sleeve. The pocket material is adapted to enable visual and haptic communication with the touchscreen user interface of the retained mobile phone. A retention pocket adjacent to the main pocket is movable between an open condition and a retaining condition overlapping the opening end of the main pocket and snugly closing of the main pocket opening. The pocket material and the retention pocket material may provide port apertures for enable cables to access an electronic device sheathed in the main and retention pockets.

### CROSS-REFERENCE TO RELATED APPLICATION

This application claims the benefit of priority of U.S. provisional application No. 63/223,883, filed 20 Jul. 2021, the contents of which are herein incorporated by reference.

### BACKGROUND OF THE INVENTION

The present invention relates to electronic device accessories and, more particularly, an electronic device handwear embodying a glove sleeve that retains a mobile phone “hands free” for outdoor activities in a main pocket by way of a pocket material along an outward facing surface of the glove sleeve. The pocket material is adapted to enable visual and haptic communication with the touchscreen user interface of the retained mobile phone.

Current designs for wearable items for retaining a mobile device come in several types, each with their own disadvantages. Designs having multiple moving parts that allow the user access to the phone, such as the wrist or forearm worn ones, have instability and insecurity issues. For instance, some keep the phone exposed by only having rubber bands engaging the phone's corners. There are reports of cracked screens from when the phone falls from these types of accessories, costing their users many hundreds of dollars. Other designs with no moving parts are worn at the outer part of the bicep, thus facing away from the body making it hard to check for notifications or even take calls. Fabric ones that are wearable on the forearm and biceps make it very hard to access the phone and very hard (forearm worn) or impossible (bicep worn) to put the phone back inside after taking it out while worn, requiring the wearer to remove the accessory to put the phone into the accessory. Fabric wrist and forearm worn designs cover the phone completely making the phone screen inaccessible because of their location in relation to the wearer's hands. Or they do not allow for placing the phone in and out of the holder with the help of both hands.

In sum, wearable phone accessories for hands-free use is impractical because during activities because they are bulky, are not secure, and require the wearer to hold the phone, and/or remove the accessory to operatively associate the mobile device.

As can be seen, there is a need for an electronic device handwear that retains a mobile phone “hands free” for outdoor activities by way of a pocket material adapted to enable visual and haptic communication with the touchscreen user interface of the retained mobile phone.

The handwear embodied in the present invention keeps the phone “on hand”, either on the backhand or on the palm, without the user having to user their fingers to hold the phone. The glove provides a pocket defined by stretchable, thin pocket material that is see-through and does not electrically insulate the touchscreen from the user's fingers, thereby enabling visual and haptic communication with the touchscreen/user interface of the retained electronic device. The design allows the user to focus on their outdoor activity such as biking or running while keeping the phone fully secure and accessible while worn. The design embodies an overlapping pocket configuration, that enables engaging and disengaging the mobile device in a matter of seconds while wearing the headwear.

The stretchable fabric makes it possible to fit phones of all sizes into the handwear with the use of both hands and leaves no risk of the phone falling off because the phone is fully enclosed through an overlapping pocket configuration. The fabric allows for the use of touchscreens and side-buttons as well as making the present invention machine washable. The overlapping pocket configuration includes a main pocket and an adjacent, shallower retention pocket that snugly overlaps the opening of the main pocket to secure the retained electronic device. The main and retention pocket material provides port apertures allowing for cables of accessories such as earphone, headphone, USB chargers, and the like to electrically couple with the retained electronic device.

The present invention allows the wearer to remove and re-sheath the electronic device in mere seconds for functions that require the use of both hands, such as typing longer messages or urgent emails. The stretchability of the present invention makes it wearable over other running gloves used for colder seasons and fits all phone and hand sizes. The present invention has no moving parts which makes it durable and makes it impossible to have a phone fall off the hand once the phone is inserted.

### SUMMARY OF THE INVENTION

In one aspect of the present invention, an apparatus includes the following: a sleeve; a main pocket and a retention pocket substantially aligned along the sleeve, wherein said pockets are facing each other, and wherein each opening of said pockets is abaft the opening of the other pocket; the main pocket is dimensioned to receive a first length of an electronic device with a touchscreen; the retention pocket is dimensioned to receive a remaining length of said electronic device and a portion of said first length so that an opening end of the retention pocket overlaps an opening end of the main pocket by an overlap portion; and wherein a material defining the main and retention pockets enables a user to visibly and haptically interact with said touchscreen.

In another aspect of the present invention, the above apparatus further includes the following: at least one port aperture along an attached end, opposing respective opening end, of each of the main and retention pockets, wherein a distance of the overlap portion is approximately three centimeters, wherein said material comprises an elastic material that that snugly retains said electronic device so that said material directly engages substantially an entire surface area of said touchscreen, wherein said material comprises approximately 92% polyester and approximately 8% polyether-polyurea copolymer, wherein the sleeve has a front surface and a rear surface sharing two opposing longitudinal edges; two thumbholes, one along each longitudinal edge; and wherein the two thumbholes are longitudinally offset relative to each other; and further including a reflector along each longitudinal edge; a key pocket and a wrist opening along the rear surface, wherein each thumbhole is approximately three centimeters in length, and wherein the two thumbholes are longitudinally offset by approximately three centimeters, and wherein a longitudinal length of the sleeve is approximately seventeen centimeters.

These and other features, aspects and advantages of the present invention will become better understood with reference to the following drawings, description, and claims.

### BRIEF DESCRIPTION OF THE DRAWINGS

FIG. 1A is a perspective view of an exemplary embodiment of the present invention, shown in a palm-fore mode, wherein an opening of a main pocket is adjacent the palm-side of the wearer's fingers. FIG. 1A illustrates how the user interface/touchscreen is visible through the pocket and retention material when the electronic device is sheathed in both the main pocket and the retention pocket.

FIG. 1B is a perspective view of an exemplary embodiment of the present invention, illustrating the electronic devices secured in the main pocket without the overlap portion of a retention pocket folded in an open condition.

FIG. 2A is a perspective view of an exemplary embodiment of the present invention, shown in a palm-aft mode wherein an opening of a main pocket is adjacent the palm-side of the wearer's wrist. FIG. 2A illustrates how the user interface/touchscreen is visible through the pocket and retention material when the electronic device is sheathed in both the main pocket and the retention pocket.

FIG. 2B is a perspective view of an exemplary embodiment of the present invention, illustrating insertion of the electronic device 60 into the main pocket 20 through the pocket opening 34.

FIG. 3 is an elevation view of an exemplary embodiment of the present invention, illustrating disposition of the port apertures.

FIG. 4 is an elevation view of an exemplary embodiment of the present invention, illustrating the reflectors.

FIG. 5 is a rear elevation view of an exemplary embodiment of the present invention, illustrating a rear surface of the sleeve 10.

FIG. 6 is a rear perspective view of an exemplary embodiment of the present invention, illustrating a key pocket 80.

FIG. 7 is a detailed elevation view of a shoulder of an exemplary embodiment of the present invention.

FIG. 8 is a rear perspective view of an exemplary embodiment of the present invention, illustrating a wrist opening 85.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides an electronic device handwear embodying a sleeve that retains a electronic device “hands free” for outdoor activities in a main pocket by way of a pocket material along an outward facing surface of the sleeve. The pocket material is adapted to enable visual and haptic communication with the touchscreen user interface of the retained mobile phone. A retention pocket adjacent to the main pocket is movable between an open condition and a retained condition overlapping the opening end of the main pocket and snugly closing off the main pocket opening. The pocket material and the retention pocket material may provide port apertures for enable cables to access the sheathed electronic device in the main and retention pockets.

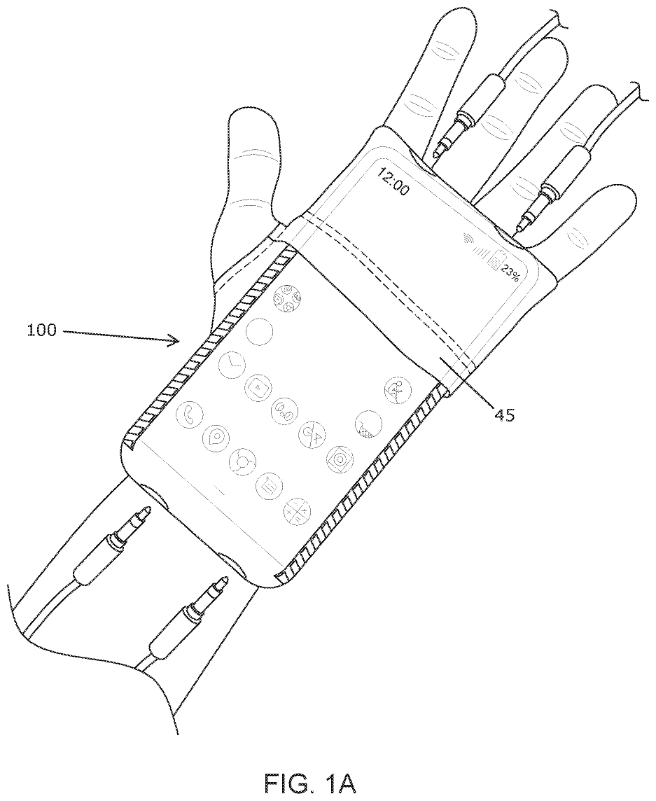

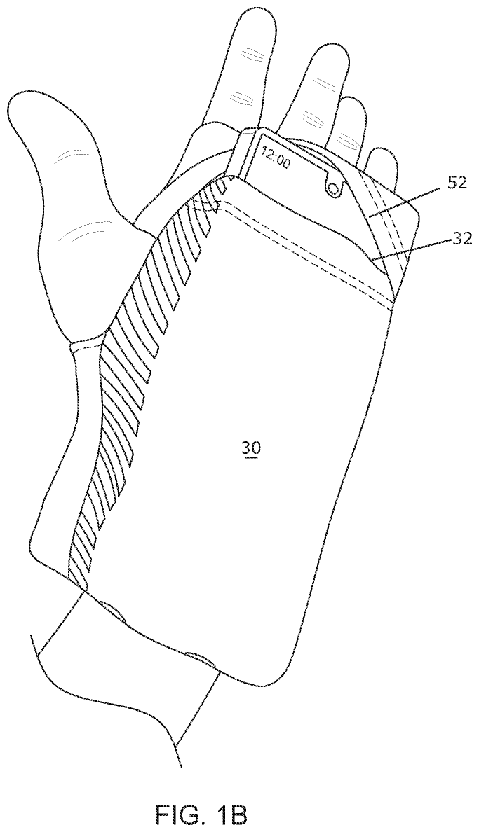

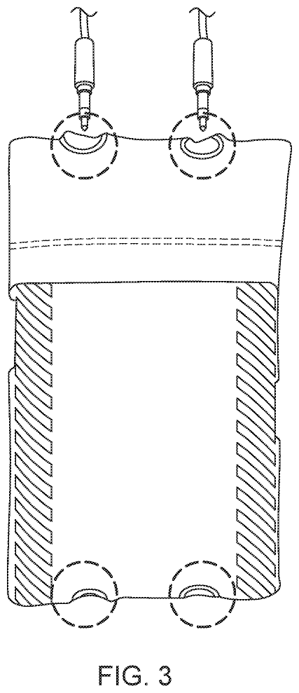

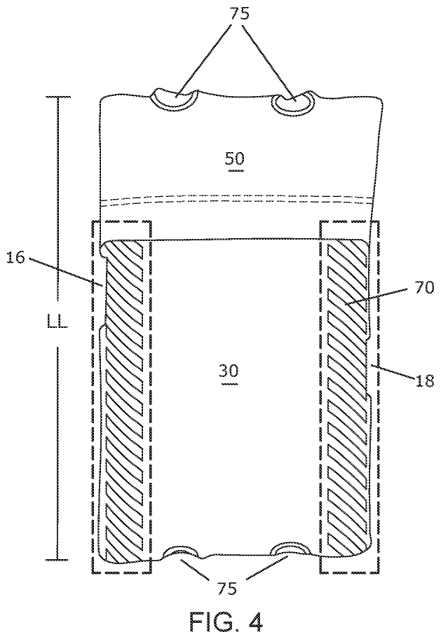

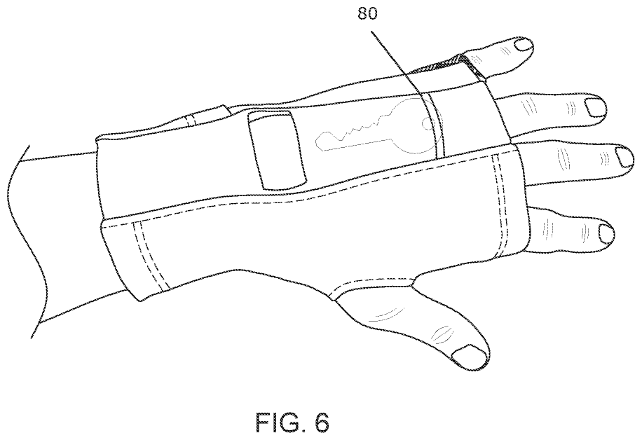

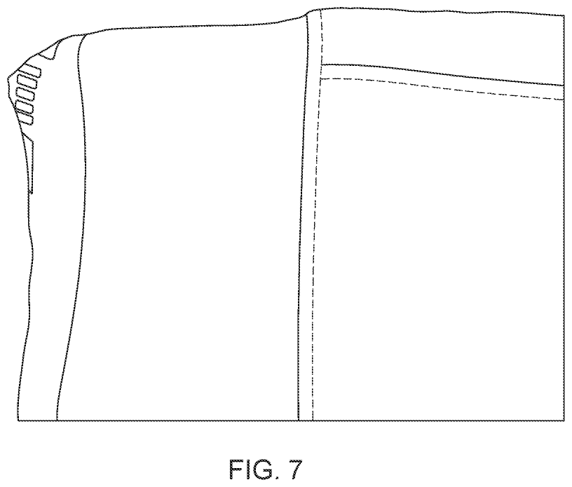

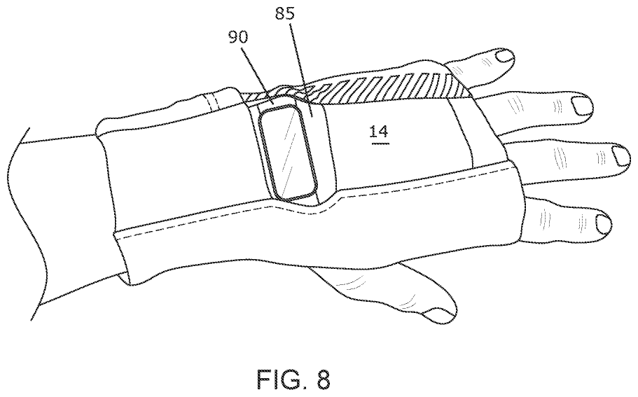

Referring now to FIGS. 1 through 8, the present invention may include an elongated sleeve 10 have having a longitudinal length (LL) greater than its width, as illustrated in FIG. 4. In certain embodiments, the longitudinal length may be approximately fifteen to nineteen centimeters, while the width may be between nine and eleven centimeters. It is understood that other lengths and widths are possible if the present invention functions as disclosed herein; for instance, the sleeve 10 enables a human user to slide the sleeve 10 over their hand, wrist, and upper portion of their forearm.

The sleeve 10 has rear surface 12 and a front surface 14. Along the front surface is a pocket 20 formed by way of a layer of pocket material 30 attached to the front surface 14. The pocket material 30 may be generally rectangular and attached along three of its four perimetral edges. The two longitudinal perimetral edges of the pocket material 30 are attached to the front surface 14, while only one of the two opposing end perimetral edges are attached, enabling the other open end perimetral edge 32 to define a pocket opening 34 that communicates with the pocket 20.

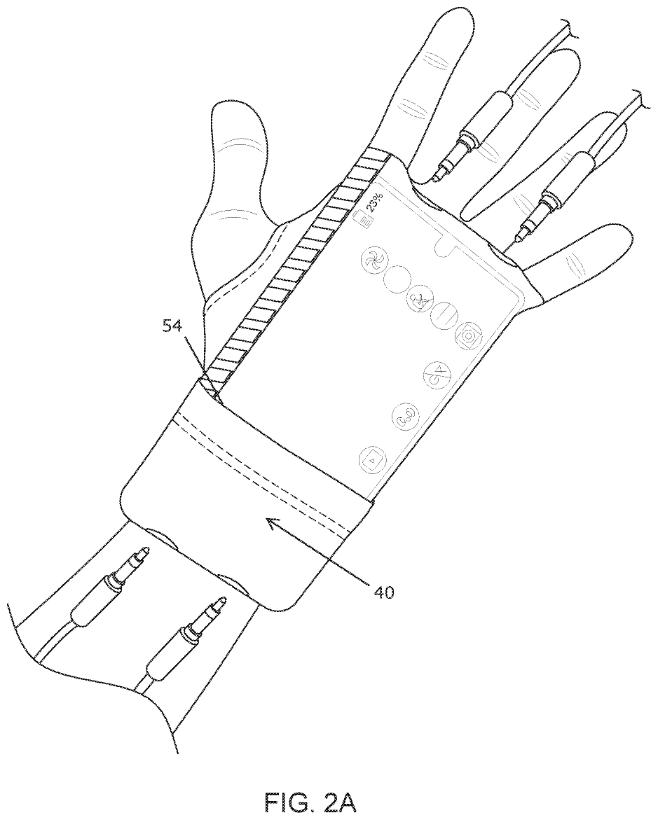

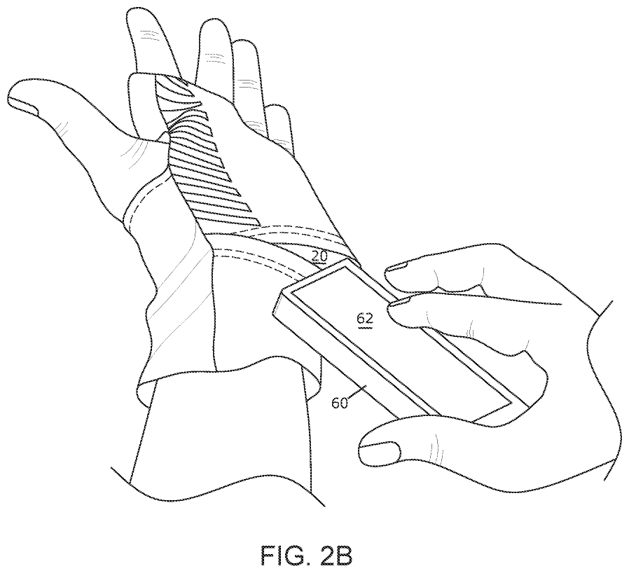

A retention pocket 40 may be defined by a generally rectangular piece of retention material 50 that is attached along three of its four perimetral edges to the front surface 14 of the sleeve 10 substantially forward of the main pocket 20. Like the pocket material 30, the retention material 50 has two longitudinal perimetral edges attached to the sleeve 10, while only one of the two opposing end perimetral edges are attached, whereby the open end perimetral edge 52 defines a retention opening 54 to a retention pocket 40. The main pocket 20 and the retention pocket 40 substantially face each other. Though the retention opening 54 is disposed aft the pocket opening 34 by approximately two to four centimeters, thereby resulting in an overlap portion 45 that partially overlaps a portion of the main pocket 20 adjacent the pocket opening 34 when the retention material 50 is moved from an open condition (see FIG. 2B) to a retained condition (see FIG. 2A). Thus, the overlap portion 45 overlaps the pocket opening 34 and a forward portion of the pocket material 30, thereby helping retain an electronic device 60 received in the main pocket 20.

It is understood that disclosure of connecting the edges of the pocket and retention material 30 and 50 to the sleeve 10 includes joining a portion just inward of the absolute edge of material 30 and 50.

Both the pocket material 30 and the retention material 50 may be made of material that enables visibly and haptic communication between a user's naked finger and the electronic device 60 sheathed in the main pocket 30. The pocket material 30 may be approximately 92% polyester and 8% Spandex (a polyether-polyurea copolymer) and sufficiently thin to facilitate the above properties: specifically, making the user interface/touchscreen 62 of the sheathed electronic device 60 visible and haptically engageable through the pocket material 30. Materials 30 and 50 have a “denier (a measure of thickness in tights—e.g., denier is the amount of transparency a certain pair of tights will have, which is directly related to its thickness. Denier ranges from 5 to 100. Transparent sheer tights can be found at the lower end of the spectrum, 5-50) of less than 40 to enable the semi-transparency or visibility of the underlying electronic device.

The sleeve 10 may have two offset opposing thumbholes 16 and 18, one thumbhole along each of the two longitudinal perimetral edges of the pocket material 30. The two thumbholes 16 and 18 may be longitudinally offset relative to each other. For instance, if the thumbholes have a length of approximately three centimeters, there may be a longitudinal distance of four centimeters between the respective midpoints of the two thumbholes 16 and 18.

The sleeve 10 may have reflectors 70 along each of the two longitudinal perimetral edges, wherein the reflectors 70 are spaced apart so as not to block the touchscreen/user interface 62 of the sheathed electronic device 60. The reflectors 70 are designed for added safety for night use while keeping a phone screen uncovered.

The component parts embodied in the handwear 100 that is stretchable to fit all sizes of hands, wherein the main pocket 20 is dimensioned and adapted to slidably and snugly receive electronic devices 60. By snugly, it is meant to convey that the pocket material 30 is tightly drawn or taught over the user interface/touchscreen 62 of the sheathed electronic device 60, further facilitating the haptic interface between the user's fingers and the touchscreen 62 as well as visibility thereof. The electronic device 60 could be securely situated either on the palm side or the back hand side of the hand, even though only palm-side orientation is shown in the illustrations.

The fingerless sleeve design and two thumbholes 16 and 18 allow for using the handwear in different modes according to the wearer's preference. Using first thumb hole 16 allows the electronic device 60 to be inserted from the top or fore portion (adjacent the wearer's fingers) leaving the touchscreen 62 to be more accessible, while using the second thumbhole 18 allows the electronic device 60 to be inserted from the bottom and or aft portion (adjacent the wearer's wrist), leaving most of the top part of the touchscreen 62 visible. The fingerless design also allows for wearing the handwear 100 in a manner that has a phone on the backhand side and either have a phone inserted from the top of the handwear 100 or from the bottom of the handwear 100.

A key slot 80 may be provided along the rear surface 12 of the sleeve 10 for holding keys and folded cash securely. A plurality of port apertures 75 gives the maximum accessibility for any cables or wires that the user may want to attach to a electronic device 60 while worn.

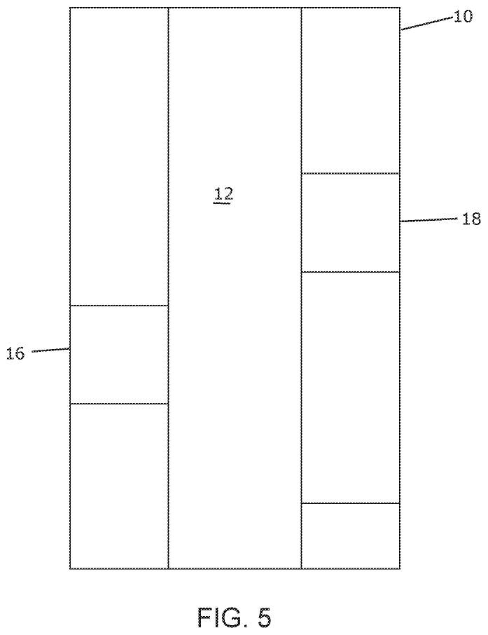

A method of making the present invention may include the following. Using a material that is stretchable, preferably a mix of approximately 8% spandex and 92% polyester, and when stretched has transparent or semi-transparent properties, the sleeve 10 may be formed as disclosed herein. In some embodiments, the sleeve 10 may be fabricated to be approximately seventeen centimeters (cm) is length and ten cm in width unworn to fit an average sized forearm. Two thumbholes 16 and 18 that may be square, 3 cm by 3 cm, may be formed from the longitudinal edges sleeve 10, as illustrated in FIG. 5, wherein the midpoint of each thumbhole is approximately 6.5 cm from a proximate end perimetral edge.

Along the front surface 14 the pocket material 30 may be attached, forming the main pocket 20 dimensioned and adapted to slidably receive an electronic device 60. The retention material 40 may be attached along the front surface 14 so that the retention pocket 40 is formed, wherein the main pocket 20 and the retention pocket 40 have diametrically opposing or directionally oppositional openings 34 and 54, respectively. These openings 34 and 54 are laterally disposed along the first surface 14 inward of the respective opening so that there is an overlap of the distal (opening) ends of both pockets 20 and 40. The overlap portion 45 may be approximately three cm, wherein the shallower retention pocket 40 is dimensioned and adapted to be the outer layer, enveloping the distal portion of the main pocket 20.

Two port apertures 75 should be formed through the retention material 50 adjacent the non-open end perimetral edge thereof, two port apertures 75 may be formed through the pocket material 50 adjacent its non-open end perimetral thereof. Each port aperture 75 may have a diameter of approximately 1.2 cm.

On the pocket material 30 there may be reflectors 70 on the left and right longitudinal perimetral edges. These reflectors 70 may span the entire length of the pocket material 30 and may be one to two cm in width.

The stretchability of the pocket material 30 is necessary to make the entire handwear 100 provide universally fit and become durable as an electronic device holder; and specifically provides a snug taught fit over the sheathed electronic device 60, facilitating the visible and haptic communication therewith.

The fingerless design is essential to keep the handwear's versatility. It is designed to be worn as a single glove and the features work best when worn on either hand. The size is adaptable for all human wearers.

The rear surface 14 may provide a wrist hole 85 enabling visibly of a wrist-worn object 90, such as a watch.

A method of using the present invention may include the following. The handwear 100 disclosed above may be provided. A person wearing the handwear 100 will no longer need to place a phone into a pocket, an arm or wrist band, or hold in hand while engaging in moderate to strenuous physical activity.

A wearer would pass the thumb through either of the two thumbholes 16 and 18, depending on whether they position their electronic device 60 in a fore mode (see FIG. 1A) an aft mode (see FIG. 2A), wherein the main pocket 20 opens adjacent the wearer's fingers or the wearer's wrist, respectively.

To secure the electronic device 60 while wearing the glove, with the retention pocket 40 in the open condition, the user may insert the electronic device 60 in the main pocket 20 through its opening 34. After the electronic device 60 is received in the main pocket 20, the overlap portion 45 of the retention pocket 40 may be moved to the retained condition, folded over the portion of the electronic device 60 protruding from the main pocket 20. To remove the electronic device 60 from the handwear 100, the wearer may pull the overlap portion 45 of the retention pocket 40 with the other hand to the open condition, exposing a portion of the electronic device 60, and then push the electronic device 60 up from the deeper end of the main pocket 20 until it can easily be taken out of the main pocket 20 completely.

Unlike having a phone in a pocket or on a wrist or arm band, a phone in the handwear 100 has most of its functions available while secured in place and without having remove the phone from the handwear 100. Removing and putting the phone back requires very little effort compared to other phone holding accessories and takes a very short amount of time.

Additionally, the present invention may also be used to keep essential items that people carry with them when leaving one's house such as debit/credit cards, IDs, wallets, and other flat items a wearer deems necessary.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. An apparatus comprising:
a sleeve;
a main pocket and a retention pocket substantially aligned along the sleeve, wherein said pockets are facing each other, and wherein each opening of said pockets is abaft the opening of the other pocket;
the main pocket is dimensioned to receive a first length of an electronic device with a touchscreen;
the retention pocket is dimensioned to receive a remaining length of said electronic device and a portion of said first length so that an opening end of the retention pocket overlaps an opening end of the main pocket by an overlap portion; and
wherein a material defining the main and retention pockets enables a user to visibly and haptically interact with said touchscreen.

2. The apparatus of claim 1, further comprising at least one port aperture along an attached end, opposing respective opening end, of each of the main and retention pockets.

3. The apparatus of claim 2, wherein a distance of the overlap portion is approximately three centimeters.

4. The apparatus of claim 3, wherein said material comprises an elastic material that that snugly retains said electronic device so that said material directly engages substantially an entire surface area of said touchscreen.

5. The apparatus of claim 4, wherein said material comprises approximately 92% polyester and approximately 8% polyether-polyurea copolymer.

6. The apparatus of claim 4, wherein the sleeve has a front surface and a rear surface sharing two opposing longitudinal edges; two thumbholes, one along each longitudinal edge; and wherein the two thumbholes are longitudinally offset relative to each other.

7. The apparatus of claim 6, further comprising a reflector along each longitudinal edge.

8. The apparatus of claim 7, further comprising a key pocket and a wrist opening along the rear surface.

9. The apparatus of claim 8, wherein each thumbhole is approximately three centimeters in length, and wherein the two thumbholes are longitudinally offset by approximately three centimeters.

10. The apparatus of claim 9, wherein a longitudinal length of the sleeve is approximately seventeen centimeters.
